(19) United States
(12) Patent Application Publication
(10) Pub. No.: US 2023/0334310 A1
(43) Pub. Date: Oct. 19, 2023

(54) MANAGING A REQUEST RATE OF A SHARED RESOURCE WITH A DISTRIBUTED LEDGER

(71) Applicant: Oracle International Corporation, Redwood Shores, CA (US)

(72) Inventor: Johnson Manuel-Devadoss, San Antonio, TX (US)

(73) Assignee: Oracle International Corporation, Redwood Shores, CA (US)

(21) Appl. No.: 17/723,831

(22) Filed: Apr. 19, 2022

(51) Int. Cl. G06N 3/08

(52) U.S. Cl. CPC G06N 3/08; H04L 67/10

(57) ABSTRACT

Techniques for managing maximum request rates to shared system resources are disclosed. A system applies a machine learning model, such as a long short-term memory (LSTM) recurrent neural network (RNN) type model to historical maximum request rate data to determine a target maximum request rate for a particular client and a particular period of time. The system obtains the historical maximum request rate data from a distributed ledger, such as a blockchain. System clients may record modifications to their maximum request rates in the blockchain. The system modifies the maximum request rates associated with the system clients authorized to access shared resources based on the modified maximum request rates contained in the new blocks added to the blockchain.

### BACKGROUND

Cloud service providers (CSPs) manage clients’ access to cloud services by throttling client requests to access the cloud services. The CSP assigns a fixed maximum request rate to a client. The CSP denies requests that exceed the fixed request rate. Assigning a fixed maximum request rate to a client may avoid denial of service (DoS) attacks from untrusted sources. However, trusted clients may have legitimate reasons to increase a request rate. For example, a client may reconfigure its cloud environment to include additional cloud resources requiring additional access requests. Clients providing subscription services to cloud services may experience increases in subscriptions, resulting in increased request rates to access the cloud services. Accordingly, client operators may need to submit a request to a CSP operator to increase their maximum request rate. A CSP operator tasked with approving or denying such requests may not have information available to determine whether (a) the source of the request is a trusted client, or (b) whether the change in the client’s maximum request rate is actually necessary for the client.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIG. 1A illustrates a system in accordance with one or more embodiments;

FIG. 1B illustrates a distributed ledger in accordance with one or more embodiments;

FIG. 2 illustrates an example set of operations for training a machine learning model to determine a target maximum request rate in accordance with one or more embodiments;

FIG. 3 illustrates a set of operations for applying a machine learning model to data obtained from a distributed ledger to modify a maximum request rate in accordance with one or more embodiments;

FIG. 4 illustrates a set of operations for applying a machine learning model to a client’s requested modification to a maximum request rate to determine whether the request is valid, in accordance with one or more embodiments;

FIG. 5 illustrates an example set of operations for authenticating a valid client requesting a modification to a maximum request rate in accordance with one or more embodiments;

FIG. 6 illustrates an example embodiment of a system that predicts a maximum request rate using an LSTM model and a blockchain; and

FIG. 7 shows a block diagram that illustrates a computer system in accordance with one or more embodiments.

### DETAILED DESCRIPTION

In the following description, for the purposes of explanation, numerous specific details are set forth in order to provide a thorough understanding. One or more embodiments may be practiced without these specific details. Features described in one embodiment may be combined with features described in a different embodiment. In some examples, well-known structures and devices are described with reference to a block diagram form in order to avoid unnecessarily obscuring the present invention.
1. GENERAL OVERVIEW
2. SYSTEM ARCHITECTURE
3. TRAINING MACHINE LEARNING MODEL TO PREDICT MAXIMUM REQEUST RATE
4. PREDICTING MAXIMUM REQUEST RATE USING MACHINE LEARNING MODEL
5. VALIDATING CANDIDATE MAXIMUM REQUEST RATE USING MACHINE LEARNING MODEL
6. VALIDATING TRUSTED CLIENTS REQUESTING TO ADD BLOCKS TO BLOCKCHAIN
7. EXAMPLE EMBODIMENT: MODIFYING MAXIMUM REQUEST RATES USING LSTM MACHINE LEARNING MODEL AND BLOCKCHAIN
8. COMPUTER NETWORKS AND CLOUD NETWORKS
9. MISCELLANEOUS; EXTENSIONS
10. HARDWARE OVERVIEW

### 1. General Overview

Systems manage clients’ access to shared resources by setting a maximum request rate. The maximum request rates specify, for each client, a maximum rate at which the clients may access a shared resource via access requests.

One or more embodiments train a machine learning model to determine a maximum request rate for a particular system client. The system trains the machine learning model with historical maximum request rate records. The records specify (a) a maximum request rate, and (b) a time associated with the maximum request rate. The system applies the machine learning model to characteristics associated with a target time period to determine the maximum request rate for a particular system client for the time period. The system may also train the machine learning model with additional request rate data including actual request rates associated with a client and work throughput rates associated with the client.

One or more embodiments record modifications to maximum request rates for system clients in a distributed ledger, such as a blockchain. Each system node accessing a shared system resource maintains a copy of the distributed ledger. The system nodes manage the distributed ledger using a consensus algorithm specifying actions performed by each system node to arrive at a consensus regarding the contents of the distributed ledger. Each ledger entry specifies: (a) a system client, (b) a maximum request rate, and (c) time information associated with the maximum request rate. Ledger entries may include additional information, such as authentication information. According to one or more embodiments, the system trains the machine learning model based on data obtained from the ledger entries of the distributed ledger.

One or more embodiments employ a long short-term memory (LSTM) artificial recurrent neural network (RNN) architecture for the machine learning model. The system provides historical ledger entries associated with the system client as input data to cells of the LSTM model. The LSTM model determines a target maximum request rate for the system client based on the historical ledger entries provided to the LSTM model as input data.

One or more embodiments modify maximum request rates for system clients based on adding ledger entries to the distributed ledger. A system client may broadcast a candidate ledger entry to nodes of each other system client. The system clients apply the consensus algorithm to validate the candidate ledger entry. When the system nodes have validated the candidate ledger entry based on applying the consensus algorithm, the system nodes each add a new ledger entry, based on the candidate ledger entry, to their respective copies of the distributed ledger. For example, if the distributed ledger is a blockchain, the system nodes each add a new block to the end of their copies of the blockchain. A cloud services provider detects new blocks on the blockchain. The cloud services manager analyzes the contents of the blocks to identify new maximum request rates for system clients. The cloud services manager modifies maximum request rates for the system clients based on new blocks added to the blockchain.

One or more embodiments apply a machine learning model to a client’s request to modify its maximum request rate to determine whether the client’s request is valid. The system trains the machine learning model using historical maximum request rate data for the client. The system applies the machine learning model to a maximum request rate value requested by the client and time information associated with the value. The model determines whether the request to modify the maximum request rate is a valid request or an invalid request. For example, the trained model may identify correlations between particular seasons and particular maximum request rates. The trained model may determine that a client’s request exceeds a maximum request rate corresponding to the historical maximum request rate data. The trained model may determine that the requested maximum request rate is invalid. According to another example, the trained machine learning model may identify a trend of increasing maximum requests rates and work throughput rates associated with a client over time. The trained model may determine that the requested maximum request rate corresponds to the identified trend. The trained model may determine that the requested maximum request rate is valid.

One or more embodiments described in this Specification and/or recited in the claims may not be included in this General Overview section.

### 2. System Architecture

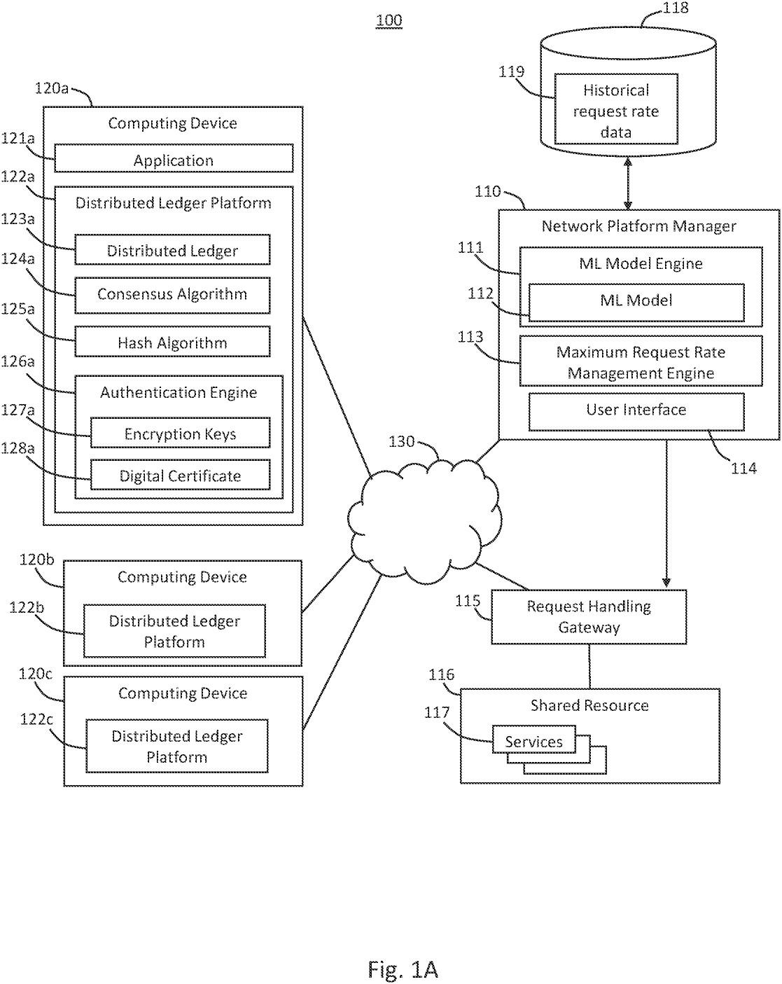

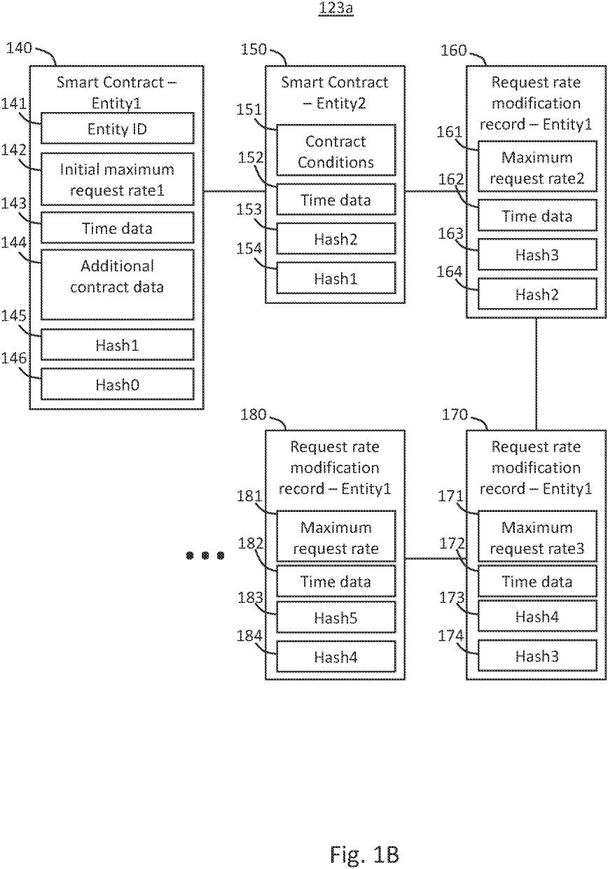

FIG. 1 illustrates a system 100 in accordance with one or more embodiments. As illustrated in FIG. 1, system 100 includes a network platform manager 110, computing devices 120a, 120b, and 120c, and a shared resource 116. The network platform manager 110, computing devices 120a, 120b, and 120c, and a shared resource 116 communicate via a network 130. A request handling gateway 115 receives requests from the computing devices 120a, 120b, and 120c. The requests handling gateway 115 may analyze the requests. If the requests are valid requests, the request handling gateway 115 transmits the requests to the shared resource 116. The shared resource 116 provides one or more services 117 to the computing devices 120a, 120b, and 120c. For example, the services 117 may include shared access to computing resources, such as hardware processors, and memory resources, such as physical memory and databases.

According to an example embodiment, the network platform manager 110 may be an application programming interface (API) platform cloud service manager. The request handling gateway 115 may be an API gateway. The API gateway may receive and analyze API requests. The API gateway may allow access to cloud services 117 based on validating the API requests.

The computing device 120a runs an application 121a. The application 121a may run based on the services 117 of the shared resource 116. For example, a service 117 may include a business platform providing business functionality, such as human resources management, procurement management, accounting, etc. Another service 117 may include a database accessed by the application 121a.

In one or more embodiments, the first, second, and third entities associated with the first, second, and third computing devices 120a-120c are tenants. A tenant may be a corporation, organization, enterprise, or other entity that accesses a shared computing resource, such as resource 116. In an embodiment, tenants associated with computing devices 120a-120c are independent from each other. A business or operation associated with computing device 120a is separate from a business or operation associated with computing device 120b.

The network platform manager 110 determines a maximum request rate permitted for each entity accessing the services 117 of the shared resource 116. As such, the network platform manager 110 is a shared resource manager managing access to shared system resources. For example, each of the computing devices 120a, 120b, and 120c may correspond to a different entity. A first entity associated with the computing device 120a may be allocated a maximum request rate of 100 requests per minute. A second entity associated with the computing device 120b may be allocated a maximum request rate of 200 requests per minute. A third entity associated with the computing device 120c may be allocated a maximum request rate of 300 requests per minute. The network platform manager 110 provides the request handling gateway 115 with maximum request rate limits for different entities. For example, the request handling gateway 115 may store a table identifying: (a) entities having permission to access the services 117 of the shared resource 116, and (b) a maximum request rate assigned to each entity. The network platform manager 110 may update the table to update the list of (a) entities having permission to access the services 117 of the shared resource 116, and (b) a maximum request rate assigned to each entity.

The computing devices 120a, 120b, and 120c include a distributed leger platform 122a, 122b, and 122c. The distributed ledger platform 122a includes a distributed ledger 123a, a consensus algorithm 124a, a hash algorithm 125a, and an authentication engine 126a. Each of the distributed ledger platforms 122b and 122c includes a respective distributed ledger, consensus algorithm, hash algorithm, and an authentication engine. The distributed ledger platforms 122a, 122b, and 122c may be blockchain platforms.

The distributed ledger platforms 122a, 122b, and 122c each store a distributed ledger. According to one embodiment, the distributed ledgers are blockchains. The distributed ledgers each store an identical set of records of modifications to maximum request rates for each entity with access to the shared resource 116. Each of the distributed ledger platforms 122a, 122b, and 122c executes the same sequence of operations specified by a consensus algorithm to agree on a present state of the system 100. In particular, the distributed ledger 123a records, for each entity permitted access to the shared resource 116, a maximum request rate. When any entity initiates a change to its particular maximum request rate, each distributed ledger platform 122a, 122b, and 122c, performs operations specified by the consensus algorithm 124a to verify the new maximum request rate and store the record of the new maximum request rate in a respective distributed ledger.

Examples of consensus algorithms include a proof of work (PoW) algorithm, a practical byzantine fault tolerance (PBFT) algorithm, a proof of stake (PoS) algorithm, a proof of burn (PoB) algorithm, and a proof of elapsed time (PoET) algorithm. In an embodiment in which the consensus algorithm 124a is a proof of work algorithm, one of the computing devices 120a, 120b, and 120c solves a resource-intensive mathematical problem. Upon solving the resource-intensive mathematical problem, the particular computing device 120a, 120b, or 120c announces a newly “mined” block, specifying a modification to an entity’s maximum request rate, to be added to the distributed ledger to the other computing devices. According to an alternative example, in an embodiment in which the consensus algorithm 124a is a proof of elapsed time algorithm, each distributed ledger platform 122a, 122b, and 122c waits a random amount of time prior to generating a block specifying a modification to an entity’s maximum request rate. The distributed ledger platform 122a, 122b, and 122c having the least timer value in a proof part validates the block.

The distributed ledger platform 122a includes a hash algorithm 125a. When posting ledger entries to the distributed ledger, the distributed ledger platforms 122a, 122b, and 122c apply the hash algorithm 125a to the ledger entry data to generate a hash digest.

An authentication engine 126a generates authentication data to authenticate entities posting ledger entries to the distributed ledger. For example, when one of the distributed ledger platforms 122a, 122b, or 122c authenticates a request to post a new ledger entry, the platform 122a, 122b, or 122c generates an authentication credential including (a) a temporary symmetric key from the encryption keys 127a, (b) a hash digest based on the requested modification to a maximum request rate, and (c) a digital certificate 128a. The distributed ledger platform 122a, 122b, or 122c broadcasts the authentication credential to each of the other distributed ledger platform 122a, 122b, or 122c. The distributed ledger platform 122a, 122b, or 122c encrypts the authentication credential with a public key, from among the encryption keys 127a, and transmits it to the distributed ledger platform 122a, 122b, or 122c that requested the new ledger entry.

FIG. 1B illustrates an example of a distributed ledger 123a, according to one or more embodiments. The distributed ledger 123a includes a smart contract 140 associated with a first entity “entity1” and a smart contract 150 associated with a second entity “entity2.” The smart contract 140 includes an entity ID 141 identifying the entity associated with the smart contract 140. An initial maximum request rate 142 specifies the initial maximum request rate associated with the first entity “entity1.” Time data 143 records temporal information associated with the smart contract 140. According to one embodiment, the time data 143 is a time stamp. A smart contract 140 may include additional contract data 144. Additional contract data 144 may include, for example, version information specifying a version of a distributed ledger, transaction counter information, nonce data, and a Merkle root. The additional contract data 144 may also include the highest “maximum request rate” that may be allotted to an entity. In other words, the maximum request rate is the maximum number of requests an entity is authorized to send to the shared resource 116 within a defined period of time, such as 100 requests per hour. Additional requests beyond the maximum request rate may be rejected by the request handling gateway 115. An entity may request modifications to its maximum request rate, such as requesting to increase the maximum request rate to 500 requests per hour, or to decrease its maximum request rate to 50 requests per hour. The additional contract data 144 may specify, for a particular entity, the maximum “maximum request rate” that an entity is authorized to request. For example, the additional contract data 144 may specify that the entity’s maximum request rate may not exceed 1000 requests per hour. Over time, the entity may request modifications to its maximum request rate within a range of 0 requests per hour to 1000 requests per hour. If the entity requests a maximum request rate exceeding 1000 requests per hour, the distributed ledger platforms 122a, 122b, and 122c may determine that the request is invalid and refrain from validating the request or generating a ledger entry associated with the request.

Each ledger entry in the distributed ledger 123a includes a hash of the data for the previous ledger entry. Since the smart contract 140 is represented in FIG. 1B as the initial ledger entry, the smart contract 140 includes an initial hash 146 “Hash0” which does not include information from any previous entry. The ledger entries in FIG. 1B also include a hash of the present ledger entry. For example, a distributed ledger platform may apply a hash algorithm to the entity ID 141, initial maximum request rate 142, time data 143, and additional contract data 144 to generate the hash digest 145 “Hash1.”

Smart contract 150 is the second ledger entry created in the distributed ledger 123a. Smart contract 150 specifies contract conditions 151, including the entity ID and initial maximum request rate, for the second entity, “entity2.” Smart contract 150 includes time data 152, a hash digest 154 “Hash1” that is the hash digest 145 from the smart contract 140. Smart contract 150 also includes a hash digest 153 “Hash 2” that is a hash of the contract conditions 151 and time data 152.

Ledger entry 160 is a record modifying the maximum request rate for the first entity, “entity1.” The ledger entry 160 includes information 161 specifying a new maximum request rate for the first entity, “entity1.” The ledger entry 160 also includes time data 162 and hash digests 163 and 164. Hash digest 164 is the same as hash digest 153 of the ledger entry 150. Hash digest 163 is a hash of the ledger data of the ledger entry 160, including the new maximum request rate 161 and the time data 162.

Ledger entry 170 is a record modifying the maximum request rate for the first entity, “entity1.” The ledger entry 170 includes information 171 specifying a new maximum request rate for the first entity, “entity1.” The ledger entry 170 also includes time data 172 and hash digests 173 and 174. Hash digest 174 is the same as hash digest 163 of the ledger entry 160. Hash digest 173 is a hash of the ledger data of the ledger entry 170, including the new maximum request rate 171 and the time data 172.

Ledger entry 178 is a record modifying the maximum request rate for the second entity, “entity2.” The ledger entry 180 includes information 181 specifying a new maximum request rate for the second entity, “entity2.” The ledger entry 120 also includes time data 182 and hash digests 183 and 184. Hash digest 184 is the same as hash digest 183 of the ledger entry 170. Hash digest 183 is a hash of the ledger data of the ledger entry 180, including the new maximum request rate 181 and the time data 182.

An identical copy of the distributed ledger 123a is maintained by each node of the system. According to one or more embodiments, nodes in the system 100 are computing devices having access to a shared resource 116. While FIG. 1A illustrates three computing devices 120a, 120b, and 120c as nodes in the system 100, embodiments include any number of nodes. Each time any node in the system generates a request to create a new ledger entry, the nodes in the system verify the ledger entry. Each node then adds the new ledger entry to its respective distributed ledger 123a. As a result, each node in the system 100 maintains a respective distributed ledger 123a with the same ledger entries as every other distributed ledger 123a.

The network platform manager 110 includes a machine learning model engine 111. The machine learning model engine 111 trains a machine learning model 112 to predict a maximum request rate for an entity accessing the shared resource 116. The machine learning model engine 111 obtains historical request rate data 119. The historical request rate data may be stored, for example, in a data repository 118. The machine learning model engine 111 also obtains historical maximum request rate modification data from the distributed ledger 123a. The historical maximum request rate modification data includes maximum request rate values and time data, such as a time that a particular maximum request rate was recorded in a ledger entry of the distributed ledger 123a. The historical request rate data includes: historical request rates over time, historical throughput rates, and target throughput rates. In one or more embodiments, historical request rate data includes event-type data, describing attributes of events associated with particular system components or times. For example, the historical maximum request rate modification data may include recurring ledger entries for a particular entity at the end of each quarter. The historical request rate data may include information about an event, such as a system-wide infrastructure scan, which occurs quarterly. The machine learning model engine 111 may train the machine learning model 112 to identify a correlation between scheduled system-wide infrastructure scans and modifications to maximum request rates. The machine learning model engine 111 trains the machine learning model 112 based on the historical maximum request rate modification data obtained from the distributed ledger 123a. The machine learning model engine 111 may optionally further train the machine learning model 112 based on the historical request rate data.

According to one or more embodiments, the machine learning model is a long short-term memory (LSTM) artificial recurrent neural network (RNN). The LSTM machine learning (ML) model receives as inputs time-based data - such as a most-recent modification to a maximum request rate for a particular entity and one or more previous modifications to the maximum request rate for the particular entity. For example, the LSTM may receive as inputs a predefined set of ledger entries of the distributed ledger 123a for a particular entity. Each ledger entry includes a modification to a maximum request rate for the entity and time information associated with the ledger entry.

The network platform manager 110 runs the machine learning model 112 to predict a maximum request rate for a particular entity. For example, computing device 120a may be associated with a first entity, such as a first enterprise. The computing devices 120b and 120c may be associated with a second entity and a third entity, respectively. While, for the purposes of this example, each computing device 120a, 120b, and 120c is associated with a separate entity, embodiment include multiple computing devices associated with a same entity. The machine learning model 112 obtains ledger entries from the distributed ledger 123a specifying modifications, over time, to the maximum request rate for the first entity. It is noted that the distributed ledger 123a maintained by the computing device 120a, and by each computing device 120a-120c, includes the ledger entries associated with modifications to the maximum request rates for each entity in the system 100 authorized to generate requests to the shared resource 116. The machine learning model 112 may also obtain additional historical request rate data 119. The machine learning model predicts, for a particular time, a maximum request rate that will be required by the first entity.

The network platform manager 110 may transmit the prediction to the respective computing device 120a, 120b, or 120c associated with the predictions. An entity associated with the computing device 120a, 120b, or 120c may generate a request, such as a candidate ledger entry, to modify its maximum request rate based on the prediction received from the network platform manager 110. The distributed ledger platforms 122a-122c may perform operations specified in the consensus algorithm 124a to validate the candidate ledger entry. Based on validating the candidate ledger entry, the ledger entry is broadcast to each distributed ledger platform 122a-122c. Each computing device 120a-120c adds a new ledger entry to its respective distributed ledger 123a based on the candidate ledger entry specifying the modified maximum request rate. The maximum request rate management engine 113 detects the change in the maximum request rate for the first entity and updates a corresponding value for the maximum request rate for the first entity in the request handling gateway 115.

While not illustrated in FIG. 1A, in one or more embodiments, the network platform manager 110 includes the distributed ledger platform 122a. The network platform manager 110 may maintain a distributed ledger 123a. The maximum request rate management engine 113 may read values form the distributed ledger 123a maintained by the network platform manager 110 to set the maximum requests rates for entities in the system 100.

The network platform manager 110 includes a user interface 114. The user interface allows a user to provide feedback to train the machine learning model 112. In addition, the user interface allows a user to generate new candidate ledger entries to modify maximum request rates for entities in the system 100. In one or more embodiments, interface 114 refers to hardware and/or software configured to facilitate communications between a user and the network platform manager 110. Interface 114 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms.

In an embodiment, different components of interface 114 are specified in different languages. The behavior of user interface elements is specified in a dynamic programming language, such as JavaScript. The content of user interface elements is specified in a markup language, such as hypertext markup language (HTML) or XML User Interface Language (XUL). The layout of user interface elements is specified in a style sheet language, such as Cascading Style Sheets (CSS). Alternatively, interface 114 is specified in one or more other languages, such as Java, C, or C++.

In one or more embodiments, a data repository 118 is any type of storage unit and/or device (e.g., a file system, database, collection of tables, or any other storage mechanism) for storing data. Further, a data repository 118 may include multiple different storage units and/or devices. The multiple different storage units and/or devices may or may not be of the same type or located at the same physical site. Further, a data repository 118 may be implemented or may execute on the same computing system as the network platform manager 110. Alternatively, or additionally, a data repository 118 may be implemented or executed on a computing system separate from the network platform manager 110. A data repository 118 may be communicatively coupled to the network platform manager 110 via a direct connection or via a network.

Information describing historical request rate data 119 may be implemented across any of components within the system 100. However, this information is illustrated within the data repository 118 for purposes of clarity and explanation.

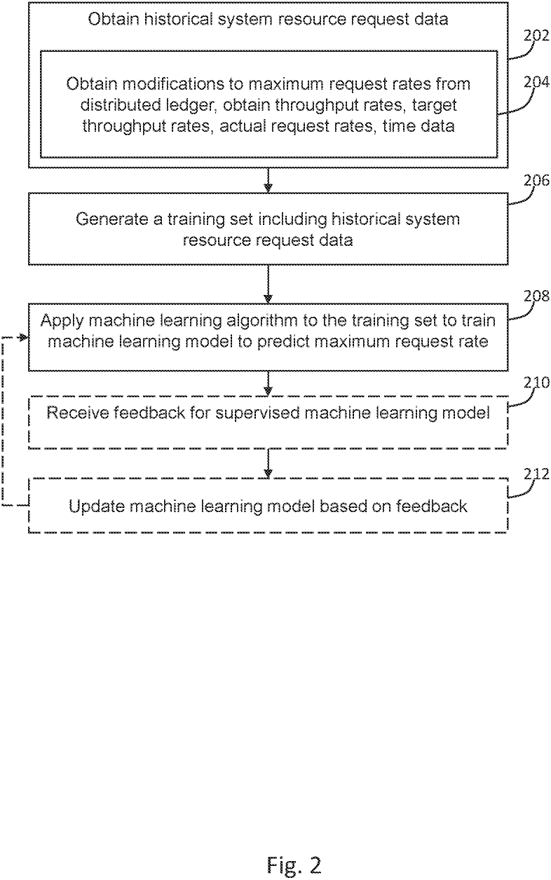

In one or more embodiments, a network platform manager 110 refers to hardware and/or software configured to perform operations described herein for generating predictions for maximum request rates and managing maximum request rates. Examples of operations for generating predictions for maximum request rates and managing maximum request rates are described below with reference to FIG. 2.

In an embodiment, the network platform manager 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, a generic machine, a function-specific hardware device, a hardware router, a hardware switch, a hardware firewall, a hardware firewall, a hardware network address translator (NAT), a hardware load balancer, a mainframe, a television, a content receiver, a set-top box, a printer, a mobile handset, a smartphone, a personal digital assistant (“PDA”), a wireless receiver and/or transmitter, a base station, a communication management device, a router, a switch, a controller, an access point, and/or a client device.

In one or more embodiments, the system 100 may include more or fewer components than the components illustrated in FIG. 1. The components illustrated in FIG. 1 may be local to or remote from each other. The components illustrated in FIG. 1 may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 8, titled “Computer Networks and Cloud Networks.”

### 3. Training Machine Learning Model to Predict Maximum Reqeust Rate

FIG. 2 illustrates an example set of operations for training a machine learning model to predict a maximum request rate for an entity authorized to access a shared resource in accordance with one or more embodiments. One or more operations illustrated in FIG. 2 may be modified, rearranged, or omitted all together. Accordingly, the particular sequence of operations illustrated in FIG. 2 should not be construed as limiting the scope of one or more embodiments.

A system obtains historical system resource request data (Operation 202). The historical resource request data includes ledger entries from a distributed ledger (Operation 204). The distributed ledger is a record of every modification to the maximum request rate allotted to each node of a distributed system. Each node in the system authorized to access a shared resource maintains a copy of the distributed ledger. When a particular node requests a modification to a maximum request rate to a shared system resource, the system generates, using a consensus algorithm, a new ledger entry in the distributed ledger for each node in the system. The ledger entry includes at least (a) the modified maximum request rate, and (b) time information, such as a timestamp.

In addition to obtaining the history of modifications to maximum request rates from the ledger entries, the system may obtain additional historical system resource request data, including: throughput rates of nodes, target throughput rates of nodes, historical measured request rates for nodes, and additional time data. The additional time data may include environmental data, such as recurring system events, such as a recurring backup or recurring system scan, that may be associated with particular times.

Once the various data (or subsets thereof) are identified in Operations 202 and 204, the system generates a set of training data (operation 206). Training data may include at least time data and a maximum request rate modification record. The training data may further include the additional historical system resource request data, including: throughput rates of nodes, target throughput rates of nodes, historical measured request rates for nodes, and additional time data. For example, for a particular distributed ledger entry including time information and a maximum request rate modification value, the system may identify a throughput rate associated with the node at the time indicated by the time data.

The system applies a machine learning algorithm to the training data set (Operation 208). The machine learning algorithm analyzes the training data set to identify data and patterns that indicate relationships between maximum request rates and particular times. In embodiments in which the training data set includes additional historical system resource request data, including: throughput rates of nodes, target throughput rates of nodes, historical measured request rates for nodes, and additional time data, the machine learning algorithm analyzes the training data set to identify data and patterns that indicate relationships between maximum request rates, the particular times, and the additional historical system resource request data.

In one or more embodiments, the machine learning algorithm is embodied in a long short-term memory (LSTM) artificial recurrent neural network (RNN) architecture. The LSTM model is trained to receive as inputs multiple ledger entries (e.g., maximum request rate and associated time data) corresponding to different time periods. The system identifies the relationships among the training data at the different periods of time to generate predictions for a maximum request rate for a particular node at a particular period of time.

In examples of supervising ML algorithms, the system may obtain feedback on the whether a particular maximum request rate should be associated with a particular node at a particular time period (Operation 210). The feedback may affirm that a particular maximum request rate should be associated with a particular node at a particular time period. In other examples, the feedback may indicate that a particular maximum request rate should not be associated with a particular node at a particular time period. Based on the feedback, the machine learning training set may be updated, thereby improving its analytical accuracy (Operation 212). Once updated, the system may further train the machine learning model by optionally applying the model to additional training data sets.

### 4. Predicting Maximum Request Rate Using Machine Learning Model

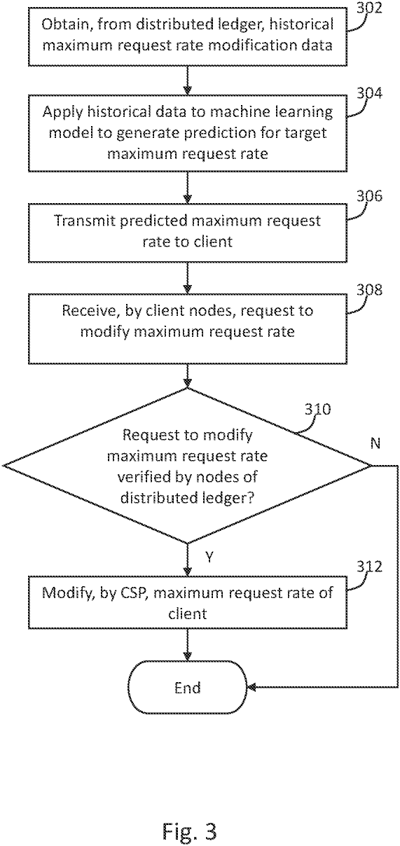

FIG. 3 illustrates an example set of operations for predicting a maximum request rate for a system client authorized to access a shared resource in accordance with one or more embodiments. One or more operations illustrated in FIG. 3 may be modified, rearranged, or omitted all together. Accordingly, the particular sequence of operations illustrated in FIG. 3 should not be construed as limiting the scope of one or more embodiments.

A system obtains, from a distributed ledger, a set of ledger entries (Operation 302). The ledger entries include records of historical request rate modifications. Each node in a system maintains a copy of a distributed ledger. Each system client may maintain at least one node in the system. Each ledger entry in the distributed ledger includes a record of a modification to a maximum request rate for a particular system client. Each distributed ledger maintained by each node includes the historical request rate modification records for the particular system client and each other client in the system that is authorized to access a shared resource. The system identifies among the ledger entries a set of entries associated with a particular system client. For example, the system may identify the most recent ten ledger entries associated with a particular system client.

The system applies the historical maximum request rate modification data to a machine learning model to generate a prediction for a target maximum request rate for a particular client in a particular period of time (Operation 304). According to one or more embodiments, the machine learning model is an LSTM-type model. The LSTM-type model receives multiple ledger entries associated with a particular system client. The LSTM model predicts a value for a maximum request rate based on analyzing the maximum requests rates of the multiple ledger entries over time. In addition to the maximum request rates, the LSTM-type model may further analyze additional historical request rate data over time, such as throughput data associated with a system client and actual request rates over time.

According to one example, the system may predict, based on applying the historical maximum request rate data to the machine learning model, that the system client will require an increased maximum request rate at a particular time. Alternatively, the system may predict that the client will require a maximum request rate less than the current maximum request rate.

According to one embodiment, the system initiates the process to generate a predicted maximum request rate for a system client based on a triggering event. The triggering event may be, for example, the passage of a predetermined period of time. For example, the system may perform a weekly update to predict the maximum request rates that the system clients will require. Alternatively, the triggering event may be a change in a system infrastructure. For example, the system may detect a change in a capacity of a shared system resource to receive access requests. The system may detect a change in request rates associated with other system clients authorized to access the shared resource. According to yet another example, a system administrator or client may initiate the process to predict a maximum request rate that a particular client will require.

The system transmits the predicted maximum request rate predicted by the machine learning model to a system client accessing the shared system resource (Operation 306). The client analyzes the predicted maximum request rate to determine whether to initiate a request to modify its maximum request rate. For example, if the system predicts a client will experience an increase in requests to a shared resource over a particular upcoming period of time, the client may decide to request an increased maximum request rate based on the prediction. Alternatively, the client may disregard the predicted maximum request rate. For example, a client may have a maximum request rate of 1,000 requests per hour. The system may predict the client will require only 500 requests per hour. The client may choose to disregard the predicted maximum request rate from the machine learning model to maintain the client’s maximum request rate at 1,000 requests per hour.

If the client decides, based on the predicted maximum request rate, to modify its maximum request rate, the client generates a candidate new ledger entry. The client broadcasts the candidate new ledger entry to each node in the system that maintains a distributed ledger (Operation 308). The candidate ledger entry includes at least a modified maximum request rate and time data. According to an example embodiment, the distributed ledger is a blockchain, and the candidate ledger entry is a new block in the blockchain.

The system determines whether the candidate ledger entry is verified by the other nodes in the system maintaining the distributed ledger (Operation 310). When the client nodes maintaining the distributed ledger receive the candidate new ledger entry, the client nodes verify the candidate new ledger entry based on a consensus algorithm. Examples of consensus algorithms include a proof of work (PoW) algorithm, a practical byzantine fault tolerance (PBFT) algorithm, a proof of stake (PoS) algorithm, a proof of burn (PoB) algorithm, and a proof of elapsed time (PoET) algorithm. In an embodiment in which the consensus algorithm is a proof-of-work algorithm, one of the client nodes solves a resource-intensive mathematical problem. Upon solving the resource-intensive mathematical problem, the particular computing client node announces a newly “mined” block, specifying a modification to the requesting client’s maximum request rate, to be added to each distributed ledger maintained by each client node. According to an alternative example, the consensus algorithm may be a proof-of-elapsed-time algorithm. Each client node waits a random amount of time prior to generating a new ledger entry based on the candidate new ledger entry. The client node having the least timer value in a proof part validates the new ledger entry.

According to yet another embodiment, the consensus algorithm may be a proof-of-stake algorithm. The client nodes may invest in a unit of value, or “coins,” of the system by locking up a particular quantity of coins “stake.” After locking up a particular quantity of coins as stake, each client node in the system begins validating candidate new ledger entries. The client nodes place “bets” on candidate new ledger entries. When a new ledger entry, based on a candidate ledger entry, is validated and added to the distributed ledger, the client nodes receive a reward in coins proportionate to their bets. The stakes of the client nodes increase based on their rewards. A particular client node having the highest economic stake in the distributed ledger network generates a new ledger entry based on the candidate ledger entry.

The client node selected according to the consensus algorithm to validate the new ledger entry applies a hash algorithm to data associated with the candidate ledger entry. The data associated with the candidate ledger entry includes, for example, the requested modification to the maximum request rate, time data, such as a timestamp, and client ID data. The hash algorithm creates a unique hash digest of a predefined length. The new ledger entry also includes the hash digest for the ledger entry immediately preceding the new ledger entry.

According to one or more embodiments, the client nodes verify the client node sending the candidate new ledger entry is a trusted client. For example, a client node transmitting the candidate new ledger entry may transmit a cryptographic key. The other client nodes may verify the client node is a trusted client by decrypting data encrypted using the cryptographic key.

Based on determining that the candidate ledger entry has been verified, the system modifies the maximum request rate for the client based on the verified ledger entry (Operation 312). For example, a cloud service provider (CSP) may access ledger entries of the distributed ledger to determine maximum request rates for each client accessing the shared cloud resource. The CSP may identify the new ledger entry specifying the modified maximum request rate for the particular client. The CSP may update a record specifying the maximum request rate for the particular client. For example, the CSP may update a table specifying shared cloud resources, clients associated with the shared cloud resources, and maximum request rates for each of the clients. The CSP may control access to the shared cloud resource based on the maximum request rates. For example, the system may include an application programming interface (API) gateway that receives and validates requests from clients to access a shared cloud resource. The CSP may send instructions to the API gateway to modify the maximum request rate for the particular client based on the new ledger entry.

### 5. Validating Candidate Maximum Request Rate Using Machine Learning Model

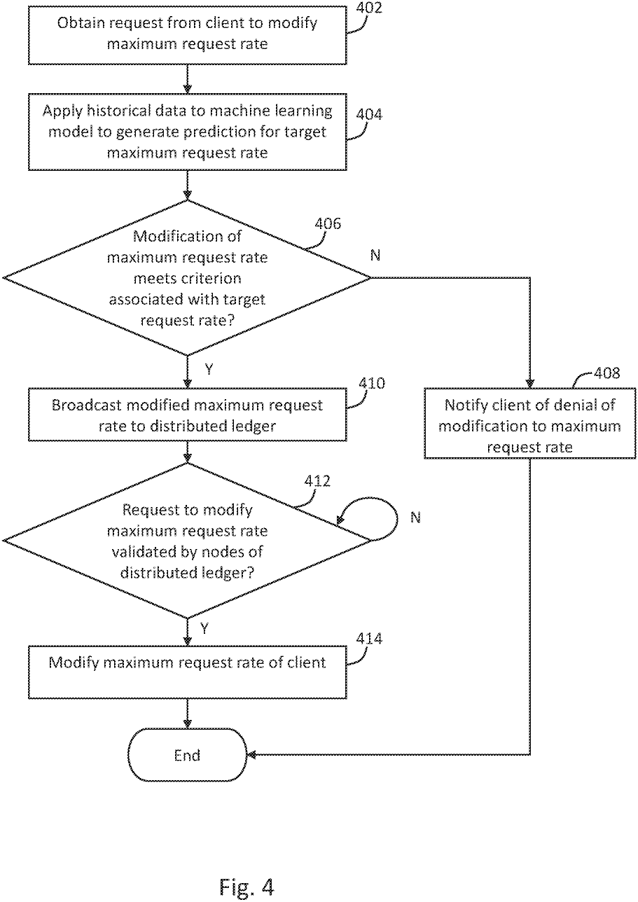

FIG. 4 illustrates an example set of operations for validating requests to modify a maximum request rate using a machine learning model in accordance with one or more embodiments. One or more operations illustrated in FIG. 4 may be modified, rearranged, or omitted all together. Accordingly, the particular sequence of operations illustrated in FIG. 4 should not be construed as limiting the scope of one or more embodiments.

A system receives a request from a client to modify a maximum request rate (Operation 402). For example, a cloud service provider (CSP) may obtain a candidate new ledger entry from a client node requesting to add the new ledger entry to a distributed ledger maintained by a set of client nodes. The candidate new ledger entry includes a request to modify a maximum request rate for the client. According to one embodiment, the CSP receives the candidate new ledger entry prior to broadcasting the candidate new ledger entry to the client nodes accessing shared resources in the cloud environment.

The system applies historical maximum request rate data to a machine learning model to generate a prediction for a target maximum request rate for the client (Operation 404). The machine learning model may be an LSTM model. The LSTM model may receive as input data a series of ledger entries from the distributed ledger. The ledger entries may be records of maximum request rate modifications for the particular client requesting a modification to its maximum request rate. The machine learning modal may further receive as inputs additional request rate data including: measured request rates over time, target request rates, measured throughput rates over time, target throughput rates, a request rate capacity of a shared system resource or API gateway, time data, and environmental data in a cloud environment.

For example, a client may periodically run an application that generates a high number of requests to the shared cloud resource. Over time, the client may generate ledger entries specifying an increase in its maximum request rate during the times that the client expects to run the application. The client may generate ledger entries specifying a decrease in its maximum request rate during the times that the client does not expect to run the application. The client may run an application that allows subscribers to access the shared cloud resource. The client may generate ledger entries incrementally increasing its maximum request rate over time as the number of subscribers increases over time. The client may modify its cloud infrastructure by adding one or more nodes to its cloud environment. The client may generate ledger entries increasing its maximum request rate to the shared cloud resource based on modifying its cloud infrastructure. The machine learning model accepts as input data the ledger entries specifying modifications to the clients’ maximum request rate. The machine learning model may also accept as input data metrics associated with the reasons for the maximum request rate modifications, such as metrics representing requests rates associated with different applications, metrics specifying a change in a number of subscribers over time, and metrics specifying attributes of a client’s cloud environment.

Based on the predicted maximum request rate for the client, the system determines whether the request from the client to modify the client’s maximum request rate meets one or more criteria associated with the maximum request rate for the client (Operation 406). For example, a CSP may store the values specifying a threshold maximum request rate allotted to each client accessing a shared cloud resource. The shared cloud resource may have a fixed aggregate maximum request rate representing the most requests per a particular period of time that the shared cloud resource is equipped to process. The CSP may allot to each client accessing the shared cloud resource a particular threshold maximum request rate, such that the sum of all the threshold maximum request rates for all of the clients does not exceed the fixed aggregate maximum request rate of the shared cloud resource. The clients may each be allotted the same threshold maximum request rates. Alternatively, different clients may be allotted different threshold maximum request rates. Over time, clients may modify maximum request rates while keeping the maximum request rates at or below the threshold maximum request rate for the client.

According to one embodiment, the system determines whether the request from the client to modify the client’s maximum request rate meets one or more criteria associated with the maximum request rate for the client by determining whether the requested maximum request rate exceeds the predicted maximum request rate for a particular time in the future. The system may deny the client’s request to modify the maximum request rate based on determining that the requested maximum request rate exceeds the prediction generated by the machine learning model.

According to another embodiment, the machine learning model generates predictions for one or more clients other than the client requesting the modification to the maximum request rate. The system may determine whether the accept or reject the requested maximum request rate for the client based on the predicted maximum request rates for the one or more additional clients. For example, a client may request to modify its maximum request rate from 1,000 requests per minute to 10,000 requests per minute. The system may predict that three other clients accessing a shared system resource would require maximum request rates of 8,000 requests per minute each. The system may calculate that the sum of the predicted maximum request rates and the client’s requested modification to its maximum request rate would exceed a request rate capacity of the shared cloud resource. The system may accordingly deny the client’s request to modify its maximum request rate to a rate of 10,000 requests per minute.

According to one embodiment, the system may identify a priority of two or more clients when determining whether the client’s requested modification to its maximum request rate meets particular criteria. For example, if the sum of the predicted maximum request rates for two clients would exceed an aggregate maximum request rate for a shared cloud resource, the system may allow a client having a higher priority to increase its maximum request rate. The system may prevent a client having a lower priority from increasing its maximum request rate.

If the system determines that the requested modification to the maximum request rate does not meet one or more criteria, the system generates a notification to the client (Operation 408). The notification may specify reasons for the denial, such as indicating that the requested maximum request rate would exceed the client’s predicted maximum request rate, a conflict exists with the requested maximum request rate and requirements of one or more other clients. According to one or more embodiments, the system may generate a recommendation for a maximum request rate for the client. For example, if the client’s request to increase its maximum request rate from 1,000 to 10,000 requests per minute is denied, the system may recommend the client increase its maximum request rate to only 5,000 requests per minute.

If the system determines that the client’s requested maximum request rate meets the criteria, the system broadcasts the modified maximum request rate to the client nodes maintaining the distributed ledger (Operation 410). According to one embodiment in which the client submits a request to a CSP to modify its maximum request rate, the CSP may generate a candidate new ledger entry based on the request. The CSP may broadcast the candidate new ledger entry to each client node that maintains the distributed ledger. According to another embodiment, the CSP transmits an approval to the client. The client then generates a candidate new ledger entry to be added to the distributed ledger. The client broadcasts the candidate new ledger entry to each node in the system that maintains a copy of the distributed ledger.

The system determines if the client’s request to modify the maximum request rate has been validated by the nodes that maintain copies of the distributed ledger (Operation 412). In particular, the nodes that maintain copies of the distributed ledger validate the new ledger entry by performing operations specified by a consensus algorithm. As discussed above, examples of consensus algorithms include a proof of work (PoW) algorithm, a practical byzantine fault tolerance (PBFT) algorithm, a proof of stake (PoS) algorithm, a proof of burn (PoB) algorithm, and a proof of elapsed time (PoET) algorithm. When a node of the distributed ledger validates the candidate new ledger entry, the validating node broadcasts the new ledger entry to each other node to attach to the end of the distributed ledger. The new ledger entry includes a new hash digest based on the data contained in the new ledger entry. The new ledger entry also includes the hash digest for the ledger entry immediately preceding the new ledger entry in the distributed ledger.

Once at least one node associated with the distributed ledger has validated the client’s request to modify its maximum request rate, the system modifies the maximum request rate of the client (Operation 414). For example, the nodes associated with the distributed ledger may validate the request by adding to the distributed ledger of each of the nodes the new ledger entry specifying the modified maximum request rate. A CSP may read the maximum request rate specified in the new ledger entry. The CSP may update one or more tables mapping maximum request rates to clients. The CSP may generate instructions for an API gateway to cause the API gateway to process requests from the client associated with the modified maximum request rate. For example, if the request to modify the maximum request rate decreases the client’s maximum request rate, the API gateway may reject requests within a defined period of time that that exceed the new maximum request rate. If the request to modify the maximum request rate increases the client’s maximum request rate, the API gateway may accept additional requests within a defined period of time, as long as the requests do not exceed the new maximum request rate.

### 6. Validating Trusted Clients Requesting to Add Blocks To Blockchain

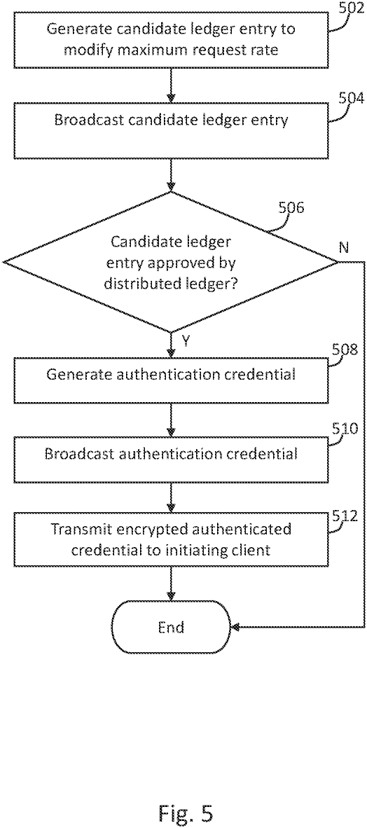

FIG. 5 illustrates an example set of operations for authenticating a trusted client for adding ledger entries to a distributed ledger in accordance with one or more embodiments. One or more operations illustrated in FIG. 5 may be modified, rearranged, or omitted all together. Accordingly, the particular sequence of operations illustrated in FIG. 5 should not be construed as limiting the scope of one or more embodiments.

A client node generates a candidate ledger entry to modify a maximum request rate (Operation 502). The candidate ledger entry include a maximum request rate modification value and time data, such as a timestamp.

The client broadcasts the candidate ledger entry to the nodes in a shared resource environment (Operation 504). Each node is associated with a client. Each node maintains a separate copy of a distributed ledger. The distributed ledger include ledger entries specifying modifications to maximum request rates for each client. The client broadcasts the candidate ledger entry together with the client’s digital signature.

The nodes validate ledger entries based on a consensus algorithm, as discussed above, to approve or reject the candidate ledger entry (Operation 506). For example, if a node attempts to validate the candidate ledger entry but generates a ledger entry having a hash digest that differs from the other nodes that maintain the distributed ledger, the nodes reject validation of the ledger entry with the incorrect hash digest value.

If the nodes approve the candidate ledger entry, one of the nodes generates an authentication credential associated with the candidate new ledger entry (Operation 508). The authentication credential includes: (a) a temporary symmetric key, (b) a hash digest for the client, and (c) the digital certificate of the client.

The node broadcasts the authentication credential to the other nodes that maintain the distributed ledger (Operation 510). Each node adds a new ledger entry associated with the candidate new ledger entry and the authentication credential to its respective copy of the distributed ledger.

The node generating the authentication credential encrypts the authentication credential and transmits the encrypted authentication credential to the client requesting the modification to its maximum request rate (Operation 512). The node may encrypt the authentication credential with a public key. The receiving node associated with the requesting client decrypts the authentication credential with its private key.

Accordingly, clients in a distributed environment that maintain a distributed ledger recording maximum request rates for each client may verify that requests to modify maximum request rates are received from trusted clients authorized to generate the requests.

### 7. Example Embodiment: Modifying Maximum Request Rates Using LSTM Machine Learning Model And Blockchain

A detailed example is described below for purposes of clarity. Components and/or operations described below should be understood as one specific example which may not be applicable to certain embodiments. Accordingly, components and/or operations described below should not be construed as limiting the scope of any of the claims.

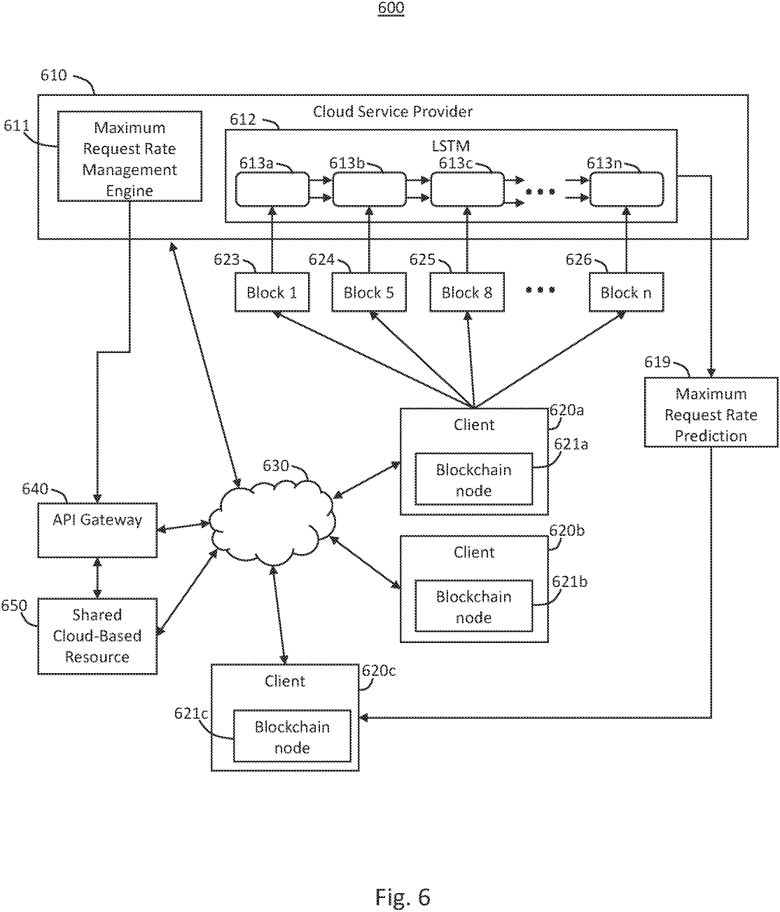

FIG. 6 illustrates a system 600 for predicting maximum request rates using an LSTM model based on blocks from a blockchain, according to one embodiment. The system 600 includes a cloud service provider (CSP) 610, clients 620a, 620b, and 620c, a network 630, an application programming interface (API) gateway 640, and a shared cloud-based resource 650.

The CSP 610 manages cloud services in a shared cloud services environment. Clients 620a, 620b, and 620c access shared cloud-based resources managed by the CSP 610. The CSP 610 may provision cloud environments for the clients 620a, 620b, and 620c. The cloud environments for the clients 620a, 620b, and 620c may share cloud-based resources, such as servers and memory. The cloud environments may include virtual environments that are partitioned from each other. For example, clients 620a, 620b, and 620c may all be tenants on the same server. The clients 620a, 620b, and 620c may not have access to the data associated with the other tenants on the server.

The clients 620a, 620b, and 620c interface with a shared cloud-based resource 650 via the network 630. According to one embodiment, the network 630 includes the Internet. The network 630 may include any combination of local and wide-area networks transmitting data between nodes using specified communication protocols. An API gateway 640 receives requests from the clients 620a, 620b, and 620c to call API functions, including functions to access the shared cloud-based resource 650. The shared cloud-based resource 650 may include one or more applications and/or stored data. The API gateway 640 enforces rate limiting. If the API gateway 640 detects that a client 620a, 620b, or 620c has initiated a number of requests within a particular period of time exceeding a maximum number of requests permitted for the client, the API gateway 640 rejects excess requests.

Each client 620a, 620b, and 620c includes a respective blockchain node 621a, 621b, and 621c. The blockchain nodes 621a, 621b, and 621c include copies of a blockchain ledger (referred to hereafter as “blockchain”) and a consensus algorithm for generating new blocks to add to the blockchain. As discussed above, examples of consensus algorithms include a proof of work (PoW) algorithm, a practical byzantine fault tolerance (PBFT) algorithm, a proof of stake (PoS) algorithm, a proof of burn (PoB) algorithm, and a proof of elapsed time (PoET) algorithm. When any one of the nodes 621a, 621b, or 621c validates a new block, the validating node broadcasts the new block to each other node to attach to the end of each respective node’s blockchain. The new block includes a new hash digest based on the data contained in the new block. The new block also includes the hash digest for the block immediately preceding the new block in the blockchain.

The blocks in the blockchain maintained by the blockchain nodes 621a-621c specify modifications to request rates for the clients 620a-620c. Each block includes: (a) identifying information about a client, (b) a value associated with a modification to a maximum request rate for the client, (c) time information associated with the block, and (d) authentication information. The authentication information includes a hash digest of the previous block in the blockchain. Blockchain node 621a includes a blockchain with each block associated with each modification to a maximum request rate for each client 620a-620c. Blockchain node 621b also includes a blockchain with each block associated with each modification to a maximum request rate for each client 620a-620c. Blockchain node 621c also includes a blockchain with each block associated with each modification to a maximum request rate for each client 620a-620c.

The CSP 610 includes a maximum request rate management engine 611. The maximum request rate management engine 611 identifies changes to maximum request rates for the clients 620a-620c. The maximum request rate management engine 611 transmits updated maximum request rate information to the API gateway 640. The API gateway 640 updates maximum request rate data for the clients 620a-620c based on the instructions received from the maximum request rate management engine 611. For example, the maximum request rate management engine 611 may read a most-recent block added to the blockchain to determine that the maximum request rate for the client 620b has increased from 100 requests per minute to 200 requests per minute. The maximum request rate management engine 611 sends the updated maximum request rate for the client 620b to the API gateway 640. The API gateway 640 updates its maximum request rate information for client 620b. The API gateway allows the client 620b to generate up to 200 requests per minute to access the shared cloud-based resource 650.

The CSP 610 includes an LSTM-type machine learning model 612. The LSTM model 612 is defined by cells 613a-613n. Each cell receives as input data: (a) a respective block 623-626 of the blockchain, and (b) data from a previous cell 613a-613c (up to 613n-1) in the LSTM model 612). Each LSTM cell 613a-613n includes gates to specify how much data from a previous cell to incorporate in each subsequent cell. For example, a gate in the cell 613b applies a sigmoid function to a value output by the cell 613a and combines the result with the input data from block 5 (624). The cells 613a-613n receive from the blocks 623-626: (a) a maximum request rate value, and (b) time data. Each block 623-626 is associated with the same client 620a, 620b, or 620c. For example, blocks 1, 5, 8, 15, 25, and 27 may be associated with client 620c. Blocks 2, 9, 20, 21, 24, and 26 may be associated with client 620a. Blocks 3, 7, 12, 13, 22, and 23 may be associated with client 620b. In the example illustrated in FIG. 6, the CSP obtains blocks 623-626 associated with modifications to the maximum request rate for client 620c from the blockchain maintained by the blockchain node 621a associated with client 620a. Since each blockchain maintained by each blockchain node 621a-621c includes each block associated with modifications to the maximum request rates for each client 620a-620c, the CSP 610 can access blocks associated with any client 620a-620c from a blockchain maintained by the same client or by any other client.

In addition to receiving as input data maximum request rate values and time data, the LSTM 612 may further receive additional data as input data. Additional data includes a throughput associated with the clients 620a-620c, a target throughput associated with the clients 620a-620c, actual request rates at given times associated with the clients 620a-620c, and a maximum aggregate request rate associated with the API gateway 640 and/or the shared cloud-based resource 650.

The LSTM 612 analyzes the input data, including the historical maximum request rate data embodied in the blocks 623-626 and generates a predicted maximum request rate 619. For example, the LSTM 612 may predict that, based on the time information associated with the modifications to the maximum request rates in the blocks 623-626, the client 620c will require an increase in its maximum request rate at a particular future time. The CSP 610 transmits the predicted maximum request rate prediction 619 to the client 620c. Based on the prediction 619, the client generates a candidate blockchain block to add to the blockchain maintained by the nodes 621a-621c. The client 620c broadcasts the candidate blockchain block to the nodes 621a-621c. The nodes 621a-621c validate the candidate blockchain block according to a particular consensus algorithm. For example, the consensus algorithm may be a proof of elapsed time (PoET) algorithm. Upon receiving the candidate blockchain block from the client 620c, each blockchain node 621a-621c waits a random amount of time prior to validating the block. For example, each blockchain node 621a-621c may wait a random amount of time prior to generating a block including a hash digest of the data in the candidate block, a hash digest of the last block in the blockchain, and a value, specified in the candidate block, for the modified maximum request rate for client 620c. The blockchain node 621a, 621b, or 621c having the least time value in a proof part of the generated block validates the block. The validating node 621a, 621b, or 621c broadcasts the validated block to each of the other nodes 621a, 621b, and 621c. Each node 621a, 621b, and 621c adds the newly-generated block specifying the new value for a maximum request rate for client 620c to the end of the blockchain maintained by the respective node. The CSP 610 reads the value from the new block and updates a maximum request rate value for the client 620c in the API gateway 640.

### 8. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis. Network resources assigned to each request and/or client may be scaled up or down based on, for example, (a) the computing services requested by a particular client, (b) the aggregated computing services requested by a particular tenant, and/or (c) the aggregated computing services requested of the computer network. Such a computer network may be referred to as a “cloud network.”

In an embodiment, a service provider provides a cloud network to one or more end users. Various service models may be implemented by the cloud network, including but not limited to Software-as-a-Service (SaaS), Platform-as-a-Service (PaaS), and Infrastructure-as-a-Service (IaaS). In SaaS, a service provider provides end users the capability to use the service provider’s applications, which are executing on the network resources. In PaaS, the service provider provides end users the capability to deploy custom applications onto the network resources. The custom applications may be created using programming languages, libraries, services, and tools supported by the service provider. In IaaS, the service provider provides end users the capability to provision processing, storage, networks, and other fundamental computing resources provided by the network resources. Any arbitrary applications, including an operating system, may be deployed on the network resources.

In an embodiment, various deployment models may be implemented by a computer network, including but not limited to a private cloud, a public cloud, and a hybrid cloud. In a private cloud, network resources are provisioned for exclusive use by a particular group of one or more entities (the term “entity” as used herein refers to a corporation, organization, person, or other entity). The network resources may be local to and/or remote from the premises of the particular group of entities. In a public cloud, cloud resources are provisioned for multiple entities that are independent from each other (also referred to as “tenants” or “customers”). The computer network and the network resources thereof are accessed by clients corresponding to different tenants. Such a computer network may be referred to as a “multi-tenant computer network.” Several tenants may use a same particular network resource at different times and/or at the same time. The network resources may be local to and/or remote from the premises of the tenants. In a hybrid cloud, a computer network comprises a private cloud and a public cloud. An interface between the private cloud and the public cloud allows for data and application portability. Data stored at the private cloud and data stored at the public cloud may be exchanged through the interface. Applications implemented at the private cloud and applications implemented at the public cloud may have dependencies on each other. A call from an application at the private cloud to an application at the public cloud (and vice versa) may be executed through the interface.

In an embodiment, tenants of a multi-tenant computer network are independent of each other. For example, a business or operation of one tenant may be separate from a business or operation of another tenant. Different tenants may demand different network requirements for the computer network. Examples of network requirements include processing speed, amount of data storage, security requirements, performance requirements, throughput requirements, latency requirements, resiliency requirements, Quality of Service (QoS) requirements, tenant isolation, and/or consistency. The same computer network may need to implement different network requirements demanded by different tenants.

In one or more embodiments, in a multi-tenant computer network, tenant isolation is implemented to ensure that the applications and/or data of different tenants are not shared with each other. Various tenant isolation approaches may be used.

In an embodiment, each tenant is associated with a tenant ID. Each network resource of the multi-tenant computer network is tagged with a tenant ID. A tenant is permitted access to a particular network resource only if the tenant and the particular network resources are associated with a same tenant ID.

In an embodiment, each tenant is associated with a tenant ID. Each application, implemented by the computer network, is tagged with a tenant ID. Additionally or alternatively, each data structure and/or dataset, stored by the computer network, is tagged with a tenant ID. A tenant is permitted access to a particular application, data structure, and/or dataset only if the tenant and the particular application, data structure, and/or dataset are associated with a same tenant ID.

As an example, each database implemented by a multi-tenant computer network may be tagged with a tenant ID. Only a tenant associated with the corresponding tenant ID may access data of a particular database. As another example, each entry in a database implemented by a multi-tenant computer network may be tagged with a tenant ID. Only a tenant associated with the corresponding tenant ID may access data of a particular entry. However, the database may be shared by multiple tenants.

In an embodiment, a subscription list indicates which tenants have authorization to access which applications. For each application, a list of tenant IDs of tenants authorized to access the application is stored. A tenant is permitted access to a particular application only if the tenant ID of the tenant is included in the subscription list corresponding to the particular application.

In an embodiment, network resources (such as digital devices, virtual machines, application instances, and threads) corresponding to different tenants are isolated to tenant-specific overlay networks maintained by the multi-tenant computer network. As an example, packets from any source device in a tenant overlay network may only be transmitted to other devices within the same tenant overlay network. Encapsulation tunnels are used to prohibit any transmissions from a source device on a tenant overlay network to devices in other tenant overlay networks. Specifically, the packets, received from the source device, are encapsulated within an outer packet. The outer packet is transmitted from a first encapsulation tunnel endpoint (in communication with the source device in the tenant overlay network) to a second encapsulation tunnel endpoint (in communication with the destination device in the tenant overlay network). The second encapsulation tunnel endpoint decapsulates the outer packet to obtain the original packet transmitted by the source device. The original packet is transmitted from the second encapsulation tunnel endpoint to the destination device in the same particular overlay network.

### 9. Miscellaneous; Extensions

Embodiments are directed to a system with one or more devices that include a hardware processor and that are configured to perform any of the operations described herein and/or recited in any of the claims below.

In an embodiment, a non-transitory computer readable storage medium comprises instructions which, when executed by one or more hardware processors, causes performance of any of the operations described herein and/or recited in any of the claims.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

### 10. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

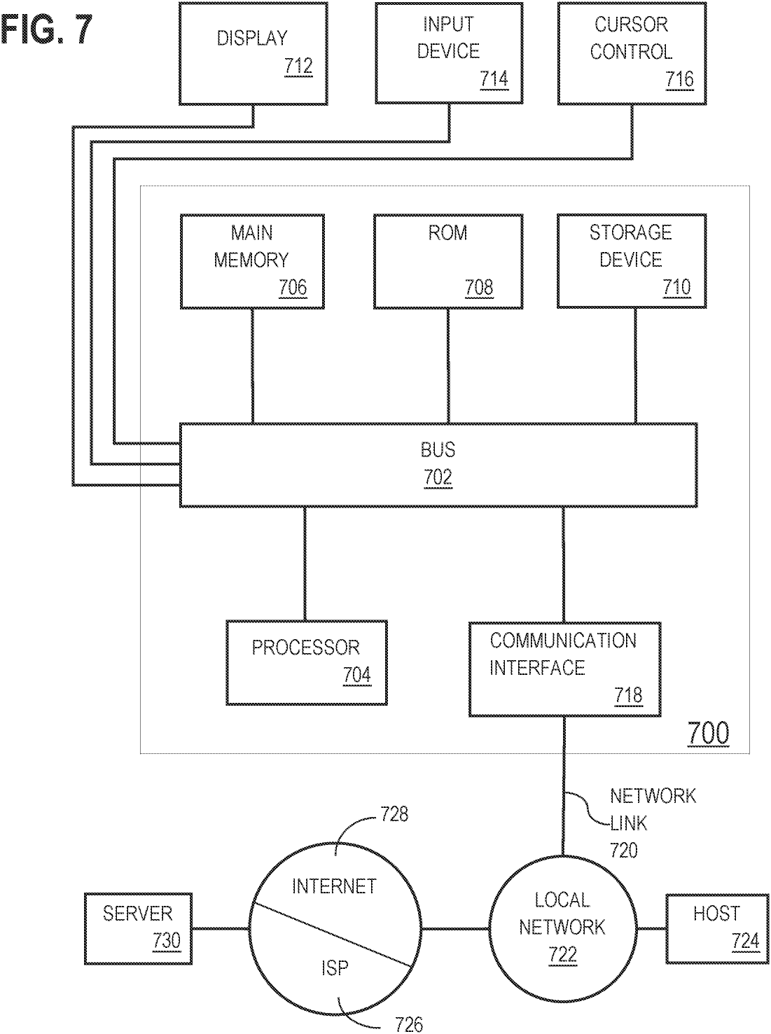

For example, FIG. 7 is a block diagram that illustrates a computer system 700 upon which an embodiment of the invention may be implemented. Computer system 700 includes a bus 702 or other communication mechanism for communicating information, and a hardware processor 704 coupled with bus 702 for processing information. Hardware processor 704 may be, for example, a general purpose microprocessor.

Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Such instructions, when stored in non-transitory storage media accessible to processor 704, render computer system 700 into a special-purpose machine that is customized to perform the operations specified in the instructions.

Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

Computer system 700 may implement the techniques described herein using customized hard-wired logic, one or more ASICs or FPGAs, firmware and/or program logic which in combination with the computer system causes or programs computer system 700 to be a special-purpose machine. According to one embodiment, the techniques herein are performed by computer system 700 in response to processor 704 executing one or more sequences of one or more instructions contained in main memory 706. Such instructions may be read into main memory 706 from another storage medium, such as storage device 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 710. Volatile media includes dynamic memory, such as main memory 706. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 702. Transmission media can also take the form of acoustic or light waves, such as those generated during radio-wave and infra-red data communications.

Various forms of media may be involved in carrying one or more sequences of one or more instructions to processor 704 for execution. For example, the instructions may initially be carried on a magnetic disk or solid state drive of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card, cable modem, satellite modem, or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the worldwide packet data communication network now commonly referred to as the “Internet” 728. Local network 722 and Internet 728 both use electrical, electromagnetic, or optical signals that carry digital data streams. The signals through the various networks and the signals on network link 720 and through communication interface 718, which carry the digital data to and from computer system 700, are example forms of transmission media.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A non-transitory computer readable medium comprising instructions which, when executed by
one or more hardware processors cause performance of operations comprising:
training a machine learning model to predict a maximum request rate for a target time period, the training comprising:
obtaining a set of historical maximum request rate modification records associated with a particular entity among a plurality of entities, each historical maximum request rate modification record comprising: (a) a new maximum request rate for the particular entity and (b) characteristics of a period of time corresponding to the historical maximum request rate modification record;
training the machine learning model based on the set of maximum historical request rate modification records;
identifying characteristics of a first target time period for determining a first maximum request rate for the particular entity; and
applying the trained machine learning model to the characteristics of the first target time period to determine the first maximum request rate for requests from the particular entity for the first target time period.

2. The non-transitory computer readable medium of claim 1, wherein the operations further comprise:
receiving a new maximum request rate modification record;
re-training the machine learning model based on the set of maximum historical request rate modification records and the new maximum request rate modification record;
identifying characteristics of a second target time period for determining a second maximum request rate for the particular entity; and
applying the re-trained machine learning model to the characteristics of the second target time period to determine the second maximum request rate for requests from the particular entity for the second target time period.

3. The non-transitory computer readable medium of claim 1, wherein the set of historical maximum request rate modification records are a set of ledger entries obtained from a distributed ledger maintained by a consensus algorithm executed on a plurality of system nodes, and
wherein the plurality of system nodes maintain a respective plurality of copies of the distributed ledger.

4. The non-transitory computer readable medium of claim 3, wherein identifying the characteristics of the target time period includes obtaining a target set of ledger entries from the distributed ledger, and
wherein each ledger entry in the target set of ledger specifies: (a) the particular entity, (b) a particular historical modification to the maximum request rate for the particular entity, and (c) time data associated with the particular historical modification to the maximum request rate for the particular entity.

5. The non-transitory computer readable medium of claim 3, wherein the operations further comprise:
based on determining the first maximum request rate for requests from the particular entity for the first target time period:
generating a candidate ledger entry specifying: (a) the particular entity, and (b) the first maximum request rate; and
broadcasting the candidate ledger entry to the plurality of system nodes.

6. The non-transitory computer readable medium of claim 5, wherein the operations further comprise:
based on broadcasting the candidate ledger entry to the plurality of system nodes:
validating, by at least one of the plurality of system nodes executing operations specified by the consensus algorithm, the candidate ledger entry;
broadcasting, by the at least one of the plurality of system nodes, a new ledger entry based on the candidate ledger entry;
adding, by the plurality of system nodes, the new ledger entry to the respective plurality of copies of the distributed ledger; and
setting, by a shared resource manager, the maximum request rate associated with the particular entity to the first maximum request rate.

7. The non-transitory computer readable medium of claim 6, wherein the distributed ledger is a blockchain, and
wherein adding, by the plurality of system nodes, the new ledger entry to the respective plurality of copies of the distributed ledger includes attaching a new block to the blockchain.

8. The non-transitory computer readable medium of claim 7, wherein the operations further comprise:
subsequent to setting the maximum request rate associated with the particular entity to the first maximum request rate:
detecting a first ledger entry added to the blockchain subsequent to the new ledger entry, the first ledger entry specifying a second maximum request rate associated with the first entity, the second maximum request rate being different than the first maximum request rate; and
setting, by the shared resource manager, the maximum request rate associated with the particular entity to the second maximum request rate.

9. The non-transitory computer readable medium of claim 3, wherein the operations further comprise:
detecting an addition of a smart contract to the distributed ledger,
wherein the smart contract specifies a second maximum request rate associated with a first entity, the first entity not among the plurality of entities; and
based on detecting the addition of the smart contract to the distributed ledger:
modifying a mapping of the plurality of entities to respective maximum request rates for the plurality of entities to include the first entity and the second maximum request rate.

10. The non-transitory computer readable medium of claim 1, wherein the machine learning model is a long short-term memory (LSTM) recurrent neural network (RNN).

11. The non-transitory computer readable medium of claim 1, wherein the machine learning model is a long short-term memory (LSTM) recurrent neural network (RNN),
wherein the set of historical maximum request rate modification records are a set of ledger entries obtained from a distributed ledger maintained by a consensus algorithm executed on a plurality of system nodes, and
wherein the plurality of system nodes maintain a respective plurality of copies of the distributed ledger,
wherein identifying the characteristics of the target time period includes obtaining a target set of ledger entries from the distributed ledger, and
wherein each ledger entry in the target set of ledger specifies: (a) the particular entity, (b) a particular historical modification to the maximum request rate for the particular entity, and (c) time data associated with the particular historical modification to the maximum request rate for the particular entity,
wherein the operations further comprise:
based on determining the first maximum request rate for requests from the particular entity for the first target time period:
generating a candidate ledger entry specifying: (a) the particular entity, and (b) the first maximum request rate; and
broadcasting the candidate ledger entry to the plurality of system nodes,
wherein the operations further comprise:
based on broadcasting the candidate ledger entry to the plurality of system nodes:
validating, by at least one of the plurality of system nodes executing operations specified by the consensus algorithm, the candidate ledger entry;
broadcasting, by the at least one of the plurality of system nodes, a new ledger entry based on the candidate ledger entry;
adding, by the plurality of system nodes, the new ledger entry to the respective plurality of copies of the distributed ledger; and
setting, by a shared resource manager, the maximum request rate associated with the particular entity to the first maximum request rate,
wherein the distributed ledger is a blockchain, and
wherein adding, by the plurality of system nodes, the new ledger entry to the respective plurality of copies of the distributed ledger includes attaching a new block to the blockchain,
wherein the operations further comprise:
subsequent to setting the maximum request rate associated with the particular entity to the first maximum request rate:
detecting a first ledger entry added to the blockchain subsequent to the new ledger entry, the first ledger entry specifying a second maximum request rate associated with the first entity, the second maximum request rate being different than the first maximum request rate; and
setting, by the shared resource manager, the maximum request rate associated with the particular entity to the second maximum request rate,
wherein the operations further comprise:
detecting an addition of a smart contract to the distributed ledger,
wherein the smart contract specifies a second maximum request rate associated with a first entity, the first entity not among the plurality of entities; and
based on detecting the addition of the smart contract to the distributed ledger:
modifying a mapping of the plurality of entities to respective maximum request rates for the plurality of entities to include the first entity and the second maximum request rate, and
wherein the operations further comprise:
receiving a new maximum request rate modification record;
re-training the machine learning model based on the set of maximum historical request rate modification records and the new maximum request rate modification record;
identifying characteristics of a second target time period for determining a second maximum request rate for the particular entity; and
applying the re-trained machine learning model to the characteristics of the second target time period to determine the second maximum request rate for requests from the particular entity for the second target time period.

12. A non-transitory computer readable medium comprising instructions which, when executed by one or more hardware processors cause performance of operations comprising:
training a machine learning model to determine whether to accept maximum request rate modifications, the training comprising:
obtaining a set of historical maximum request rate modification records associated with a particular entity among a plurality of entities, each historical maximum request rate modification record comprising: (a) a new maximum request rate for the particular entity and (b) characteristics of a period of time corresponding to the historical maximum request rate modification record;
training the machine learning model based on the set of maximum historical request rate modification records;
receiving a first maximum request rate modification for requests from the particular entity for a first time period;
applying the trained machine learning model to the first maximum request rate modification and characteristics of the first time period to classify the first maximum request rate modification as a valid request;
receiving a second maximum request rate modification for requests from the particular entity for a second time period; and
applying the trained machine learning model to the second maximum request rate modification and characteristics of the second time period to classify the second maximum request rate modification as an invalid request.

13. The non-transitory computer readable medium of claim 12, wherein the set of historical maximum request rate modification records are a set of ledger entries obtained from a distributed ledger maintained by a consensus algorithm executed on a plurality of system nodes, and
wherein the plurality of system nodes maintain a respective plurality of copies of the distributed ledger.

14. The non-transitory computer readable medium of claim 12, further comprising:
subsequent to classifying the second maximum request rate modification as an invalid request:
receiving a user input corresponding to the second maximum request rate modification, the user input classifying the second maximum request rate modification as a valid request; and
retraining the machine learning model based on the second maximum request rate modification being classified as a valid request.

15. A method comprising:
training a machine learning model to predict a maximum request rate for a target time period, the training comprising:
obtaining a set of historical maximum request rate modification records associated with a particular entity among a plurality of entities, each historical maximum request rate modification record comprising: (a) a new maximum request rate for the particular entity and (b) characteristics of a period of time corresponding to the historical maximum request rate modification record;
training the machine learning model based on the set of maximum historical request rate modification records;
identifying characteristics of a first target time period for determining a first maximum request rate for the particular entity; and
applying the trained machine learning model to the characteristics of the first target time period to determine the first maximum request rate for requests from the particular entity for the first target time period.

16. The method of claim 15, wherein the set of historical maximum request rate modification records are a set of ledger entries obtained from a distributed ledger maintained by a consensus algorithm executed on a plurality of system nodes, and
wherein the plurality of system nodes maintain a respective plurality of copies of the distributed ledger.

17. The method of claim 16, wherein identifying the characteristics of the target time period includes obtaining a target set of ledger entries from the distributed ledger, and
wherein each ledger entry in the target set of ledger specifies: (a) the particular entity, (b) a particular historical modification to the maximum request rate for the particular entity, and (c) time data associated with the particular historical modification to the maximum request rate for the particular entity.

18. The method of claim 16, further comprising:
based on determining the first maximum request rate for requests from the particular entity for the first target time period:
generating a candidate ledger entry specifying: (a) the particular entity, and (b) the first maximum request rate; and
broadcasting the candidate ledger entry to the plurality of system nodes.

19. The method of claim 18, further comprising:
based on broadcasting the candidate ledger entry to the plurality of system nodes:
validating, by at least one of the plurality of system nodes executing operations specified by the consensus algorithm, the candidate ledger entry;
broadcasting, by the at least one of the plurality of system nodes, a new ledger entry based on the candidate ledger entry;
adding, by the plurality of system nodes, the new ledger entry to the respective plurality of copies of the distributed ledger; and
setting, by a shared resource manager, the maximum request rate associated with the particular entity to the first maximum request rate.

20. A system comprising:
one or more processors; and
memory storing instructions that, when executed by the one or more processors, cause the system to perform operations comprising:
training a machine learning model to predict a maximum request rate for a target time period, the training comprising:
obtaining a set of historical maximum request rate modification records associated with a particular entity among a plurality of entities, each historical maximum request rate modification record comprising: (a) a new maximum request rate for the particular entity and (b) characteristics of a period of time corresponding to the historical maximum request rate modification record;
training the machine learning model based on the set of maximum historical request rate modification records;
identifying characteristics of a first target time period for determining a first maximum request rate for the particular entity; and
applying the trained machine learning model to the characteristics of the first target time period to determine the first maximum request rate for requests from the particular entity for the first target time period.
